(19) United States
(12) Patent Application Publication
(10) Pub. No.: US 2007/0096938 A1
(43) Pub. Date: May 3, 2007

(54) System and method for adaptation of wireless remote controls

(76) Inventors: Emmanuel Enrique Lopez, Georgetown, TX (US); Michael Penano Laranang, Georgetown, TX (US); John M. Milburn, Georgetown, TX (US)

Correspondence Address: FISH & RICHARDSON P.C., P.O BOX 1022, Minneapolis, MN, 55440-1022, US

(21) Appl. No.: 11/263,056

(22) Filed: Oct. 31, 2005

(51) Int. Cl. H04Q 7/20

(52) U.S. Cl. 340/825.69; 455/521

(57) ABSTRACT

The invention provides the ability to upgrade or update a remotely controlled system without removal or replacement of the existing remote control receiver. A preferred embodiment utilizes all or part of the existing wireless remote control in a wireless remote adapter cartridge that electrically and/or mechanically actuates the existing remote control. The wireless remote adapter cartridge is actuated by a wireless receiver that receives commands from a wireless user remote control. In one embodiment, the invention permits one wireless user remote control to control several disparate remotely controlled systems.

### TECHNICAL FIELD OF THE INVENTION

This invention relates generally to wireless remote controls and more particularly to a system and method for adapting one or more existing wireless remote controls for use with another wireless remote control system.

### BACKGROUND OF THE INVENTION

Wireless remote controls are commonly used to control functions of keyless entry systems, security systems, televisions, and other consumer electronics. For example, keyless entry systems provide keyless entry to vehicles, such as locking/unlocking or opening/closing the vehicle's doors, or in the case of buildings, opening/closing doors. A wireless remote control has a radio frequency (RF) or infrared (IR) transmitter, which communicates with a receiver in the remotely controlled system. The remote control is matched to a specific remotely control system receiver in at least two respects. First, each receiver is matched to a specific model of remote control that is designed to work with that particular system. The transmitter in the remote control must be compatible with the receiver in the system in terms of frequency (for RF-based remotes), wavelength (for IR-based remotes), pulse repetition frequency, coding scheme, and so on. Second, each receiver and its corresponding remote control may be programmed with the same coded information to permit only the intended remote control to access the remotely controlled system, such as a remote control used for keyless entry to a vehicle. Older remote controls use a fixed code for each function, i.e., the same code is transmitted by the remote control each time the user presses a particular button or key. Newer remote controls for vehicles use rolling codes, in other words, the code for each function changes each time a particular button or key is pressed, and the transmitter and receiver are synchronized by a common algorithm.

Wireless remote control systems are typically proprietary and cannot be upgraded or updated without complete replacement of the remote controls and the remote control receiver in the system controlled. This approach is expensive, complex, and otherwise impractical for most systems that are controlled by wireless remote controls.

The only known prior art approach to the aggregation of multiple wireless remote controls is the use of an IR remote control for consumer electronics that can “learn” the codes for existing remote control functions. However, this approach does not provide any greater capability beyond that provided by the existing remote controls, only aggregation.

There exists a need, not met by the state of the art, to upgrade or improve an existing wireless remote control system without replacement or removal of the existing remote control system. Another need not solved in the art is the requirement to combine or aggregate control of a plurality of disparate remotely controlled systems in one wireless remote control, using at least part of the components of the existing remote controls.

### SUMMARY OF THE INVENTION

The present invention is directed to a system and method for upgrading an existing wireless remote control system while using at least part of the existing wireless remote control. In another aspect of the present invention, a system and method is provided for combining or aggregating control over several disparate wireless remote control systems into one wireless remote control.

The invention implements a wireless remote adapter system that interfaces with one or more remotely-controlled or keyless entry systems (native systems) by incorporating a remote control (or parts thereof) that is originally designed for (or able to program to) said native systems. This approach enables the wireless remote adapter system to control each native system while also having the ability to introduce new functions to the native systems through the features of the wireless remote adapter system.

The advantages of the present invention over the known prior art include, but are not limited to 1) “plug-and-play” installation with no need to splice wires; 2) the ability to control multiple disparate systems through one wireless remote device; 3) the ability to extend the features of an existing remotely controlled system without the need to remove or replace it or install (through tedious wired installation) another system; 4) the ability to continue to use the existing remote control of a native system in conjunction with the new remote control and the enhanced capabilities of the remote adapter system; 5) the ability to exceed the maximum number of remotes a native system might be limited to; and 6) the flexibility to change the form factors of the remote controls.

The present invention facilitates upgrades of existing keyless entry systems and the remote controls that operate them, without removal of the existing system receiver or the splicing of electrical wires. Examples of the types of plug-and-play upgrades facilitated by the invention are 1) multi-vehicle remote control, in which one master remote control operates one or more vehicles; 2) passive keyless entry that automatically unlocks and locks vehicle based on user proximity; 3) Bluetooth integration, permitting authentication and operation using any Bluetooth-enabled devices such as cellular telephones, personal digital assistants (PDA), laptop computers, or any other Bluetooth enabled device; 4) long-range two-way remote controls that notify the user upon vehicle alarm activation; 5) ease and affordability of additional remotes, avoiding the high price of OEM remotes and associated programming fees; 6) innovative remote control form factors, facilitating hybrid devices such as combined key remotes, watch remotes, necklace remotes, etc.; and 7) personalized remote control colors and styles.

The invention is comprised of four components: 1) a wireless user remote control; 2) a wireless remote adapter cartridge, one for each type of vehicle or other wireless remotely-controlled system; 3) a wireless remote adapter receiver module, which wirelessly interfaces with the wireless user remote control; and 4) the remote control adapter, which houses the wireless remote adapter cartridge and wireless remote adapter receiver module, and receives power from the vehicle.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 shows a wireless remote control adapter system according to a preferred embodiment of the present invention.

FIG. 2A shows an example of a wireless user remote control capable of controlling three disparate systems.

FIG. 2B shows an alternative embodiment of the wireless user remote control.

FIG. 3 shows the wireless remote adapter receiver used in accordance with a preferred embodiment of the invention.

FIG. 4 illustrates the arrangement of the receiver and cartridge within the wireless remote adapter.

FIG. 5A shows an exemplary wireless remote adapter cartridge.

FIG. 5B shows further detail of an exemplary wireless remote adapter cartridge.

FIG. 5C shows an alternative embodiment of the wireless remote adapter cartridge.

Like reference symbols in the various drawings indicate like elements.

### DETAILED DESCRIPTION OF THE PREFERRED EMBODIMENT

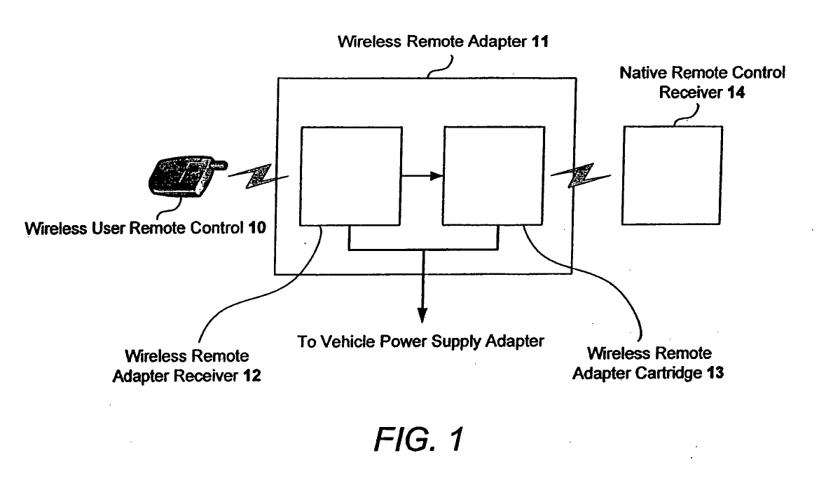

The preferred embodiment of the present invention, as depicted in FIG. 1, includes four components: wireless user control 10, wireless remote adapter 11, wireless remote adapter receiver 12, wireless remote adapter cartridge 13, and native remote control receiver 14.

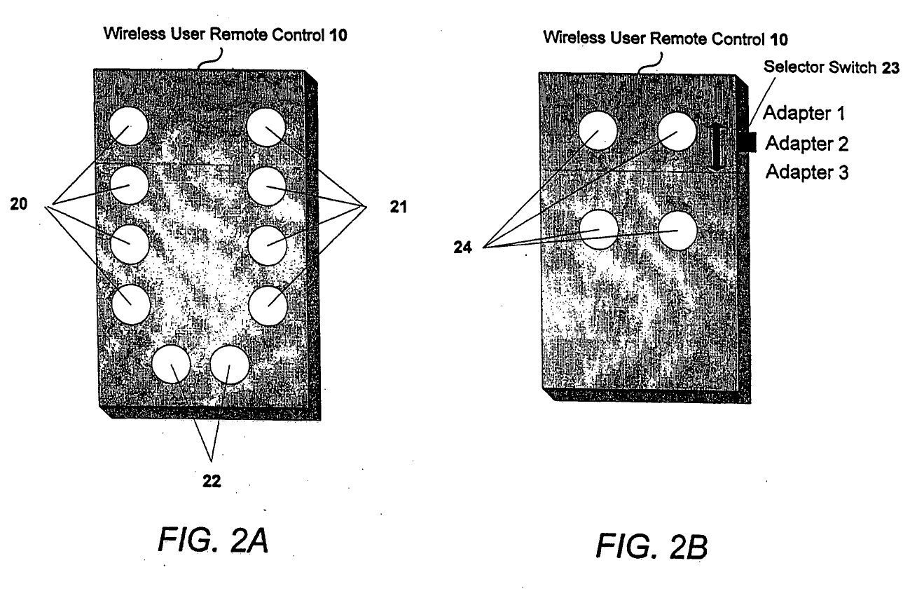

Wireless user remote control 10 is a wireless remote control capable of controlling one or more RF or IR remote control systems. FIG. 2A shows an example of a wireless user remote control capable of controlling three disparate systems, using function buttons 20, 21, and 22. For example, function buttons 20 control one remotely controlled system such as a first vehicle, function buttons 21 control another, different remotely controlled system such as second vehicle, and function buttons 22 control a third remotely controlled system such as a garage door opener.

FIG. 2B shows an alternative embodiment of wireless user remote control 10, in which there is only one set of function buttons 24 that are shared by several wireless remote adapters, but only one at a time. In the embodiment depicted in FIG. 2B, the user must select the desired wireless remote adapter by setting selector switch 23. For example, setting selector switch 23 to Adapter 1 would permit remote control of vehicle 1, while selection of Adapter 2 would permit control of vehicle 2, and so forth.

Wireless user remote control 10 can be implemented using any remote control transmitter known in the art without departing from the scope and intent of the present invention. The fundamental requirement of wireless user remote control 10 is to have sufficient channels available to control the number of desired wireless remote adapters and the respective functions on each wireless remote adapter.

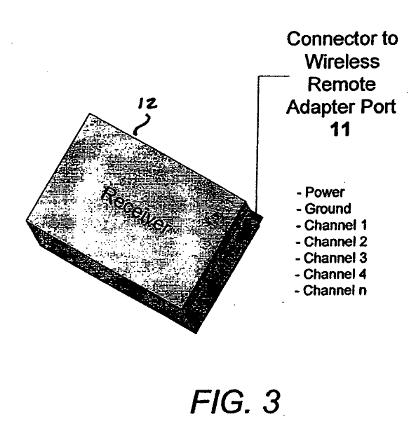

FIG. 3 shows the wireless remote adapter receiver 12 used in accordance with a preferred embodiment of the invention. Wireless remote adapter receiver 12 receives RF or IR control signals from wireless user remote control 10, which causes the state of one or more channels, identified as channels 1 through n on FIG. 3, to change accordingly. For example, if channel 1 of wireless remote adapter receiver 12 is associated with the vehicle door lock function, pressing the button on wireless user remote control 10 for door lock will change the state of the channel 1 output of the receiver. Wireless remote adapter receiver 12 can be implemented using any remote control receiver known in the art without departing from the scope and intent of the present invention. The fundamental requirement of wireless remote adapter receiver 12 is to have sufficient channels available to control the number of desired functions on the wireless remote adapter within which the receiver is housed.

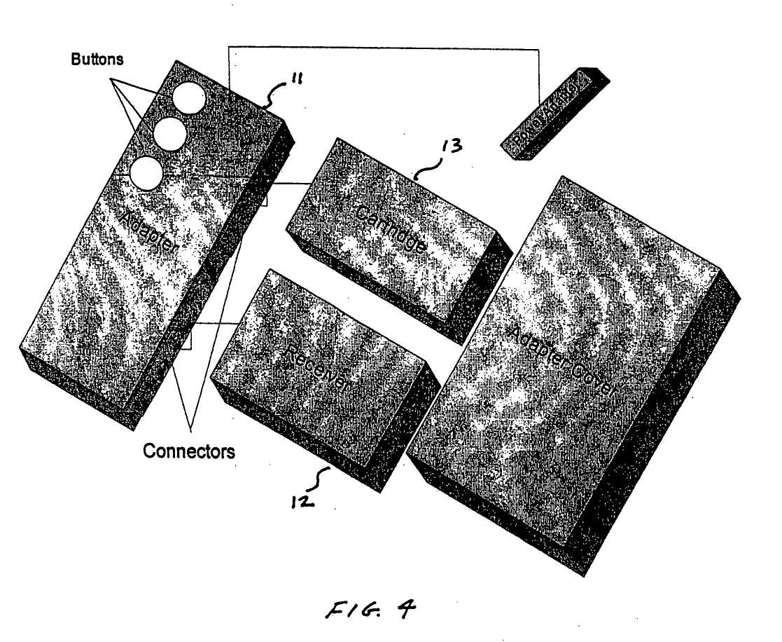

FIG. 4 illustrates how receiver 12 and cartridge 13 of the invention are housed within the wireless remote adapter 11. Wireless remote adapter 11 provides the power supply to receiver 12 and cartridge 13 as well as connectivity between them using either a backplane or wiring harness, or a combination of both. Wireless remote adapter 11 receives its power supply from the vehicle, preferably with an adapter (the wireless remote adapter port) that connects to the vehicle's onboard diagnostics (OBD) port. Typically, a vehicle's OBD port is always powered on, even when the vehicle is turned off, providing a constant power source. Additionally, the use of the OBD port makes it unnecessary to splice into the vehicle's wiring system. In the preferred embodiment, the connector to the OBD port includes an OBD pass-through to permit a service provider to access the OBD port without disturbing or disconnecting the invention.

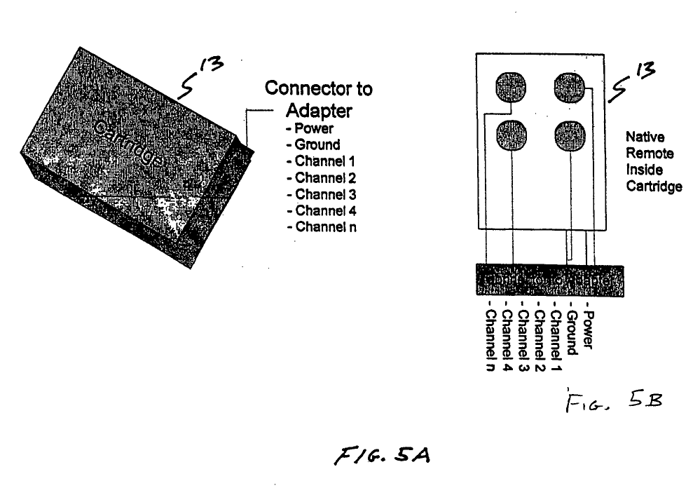

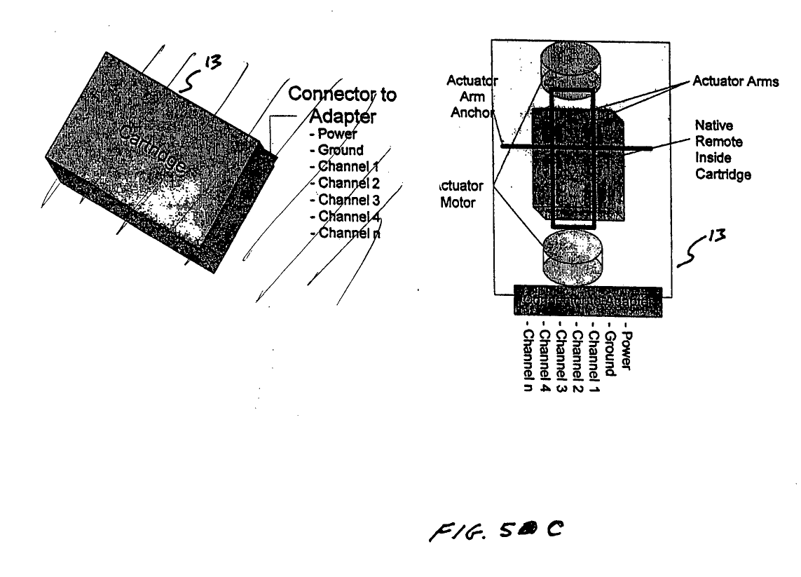

FIG. 5A shows an exemplary wireless remote adapter cartridge 13. Each such cartridge is specific to a particular vehicle or remotely controlled system, and contains all or part of the original remote control associated with the vehicle's existing keyless entry system. FIG. 5B shows further detail of an exemplary wireless remote adapter cartridge 13, in which the existing wireless remote control has been electrically connected to the cartridge connector, which connects cartridge 13 to wireless remote adapter receiver 12 through the wireless remote adapter 11. For example, when channel 1 is asserted by the wireless user remote control, the switch associated with that channel on the existing remote control within the cartridge 13 will be actuated.

FIG. 5C shows an alternative embodiment of the invention in which cartridge 13 contains an existing remote control that is mechanically actuated upon assertion of one or more channels by receiver 12. For example, when channel 1 is asserted by receiver 12, a motor or other actuating device capable of controlled motion will press the button or key associated with the function assigned to channel 1.

To install the invention in a vehicle, the wireless remote adapter port is plugged into the vehicle's OBD port for power supply and secured appropriately. The vehicle's keyless entry system is programmed using original equipment programming procedures, if necessary, and the wireless remote adapter receiver is programmed to match the wireless user remote control.

A number of embodiments of the invention have been described. Nevertheless, it will be understood that various modifications may be made without departing from the spirit and scope of the invention. For example, while the invention has been described with reference to keyless entry systems used in vehicles, it is equally applicable to any application that uses wireless (RF or IR) remote controls. Accordingly, other embodiments are within the scope of the following claims.

What is claimed is:

1. A system for adapting wireless remote controls, the system comprising:
one or more wireless remote adapter cartridges, each operable to actuate one or more functions of an existing wireless remote control housed within said wireless remote adapter cartridge;
one or more wireless remote adapter receivers coupled to the wireless remote adapter cartridges, each operable to actuate one or more functions of said one or more wireless remote adapter cartridges;
a wireless user remote control having a wireless transmitter adapted to transmit commands to the one or more remote control adapter receiver modules.

2. The system of claim 1 further comprising a wireless remote adapter that houses the one or more wireless remote adapter cartridges and the one or more wireless remote adapter receiver modules.

3. The system of claim 2 in which the wireless remote adapter further comprises a power supply coupling for providing power to the one or more wireless remote adapter cartridges and the one or more wireless remote adapter receivers.

4. The system of claim 1 further comprising at least two of the one or more wireless remote adapter receivers, and in which the wireless user remote control comprises two or more sets of function buttons, each set of function buttons operable to transmit signals intended for decoding by a selected one of the at least two wireless remote adapter receivers.

5. The system of claim 1 further comprising two wireless remote adapter receivers, and in which the wireless user remote control comprises first and second function-setting buttons and a common set of function buttons, the first and second function-setting buttons operably coupled to the common set of function buttons such that, after activating the first function-setting button, the common set of function buttons are configured to transmit signals, intended for decoding by a selected first one of the two wireless remote adapter receivers and such that, after activating the second function-setting button, the common set of function buttons are configured to transmit signals, intended for decoding by a selected second one of the two wireless remote adapter receivers.

6. A method of remotely controlling two remote devices, the method comprising the steps:
mechanically coupling a first original device remote control to a first remote button actuator assembly;
mechanically coupling a second original device remote control to a second remote button actuator assembly;
remotely and wirelessly controlling the first remote button actuator assembly to push buttons on the first original device remote control, thereby controlling the first remote device;
remotely and wirelessly controlling the second remote button actuator assembly to push buttons on the second original device remote control, thereby controlling the second remote device.

7. The method of claim 6 in which the steps of remotely and wirelessly controlling the first and second remote button actuator assemblies may be accomplished by a first user remote control or a second user remote control.

8. The method of claim 6 further comprising the step of inserting the first original device remote control into a first remote control adapter cartridge connected to the first remote button actuator assembly.

9. The method of claim 8 further comprising the step of inserting the first remote control adapter cartridge into a first remote control adapter port.

10. A method of remotely controlling one or more devices, the method comprising the steps:
mechanically coupling an a first original device remote control to a first remote button actuator assembly;
remotely and wirelessly controlling the first remote button actuator assembly to push buttons on the first original device remote control, thereby controlling the first remote device.

11. The method of claim 10 further in which the step of remotely and wirelessly controlling the first remote button actuator assembly may be accomplished with a first user remote control or a second user remote control.

12. The method of claim 11 further comprising the step of inserting the first original device remote control into a first remote control adapter cartridge connected to the first remote button actuator assembly.

13. The method of claim 12 further comprising the step of inserting the first remote control adapter cartridge into a first remote control adapter port.
